(19) United States
(12) Patent Application Publication
(10) Pub. No.: US 2016/0139834 A1
(43) Pub. Date: May 19, 2016

(54) Automatic Configuration of Local Storage Resources

(71) Applicant: Cisco Technology, Inc., San Jose, CA (US)

(72) Inventor: Geoffrey H. Hanson, San Jose, CA (US)

(21) Appl. No.: 14/541,455

(22) Filed: Nov. 14, 2014

(51) Int. Cl. G06F 3/06; H04L 29/08

(52) U.S. Cl. CPC G06F 3/0619; H04L 67/30; G06F 3/0689; G06F 3/0665

(57) ABSTRACT

A management controller is provided for provisioning a server with local storage. The management controller receives a service profile that includes a set of local storage criteria. The management controller associates the first service profile with a physical server, and directs a storage controller to create one or more virtual drives that conform to the set of local storage criteria. The management controller provides local storage for the physical server from the virtual drive.

### TECHNICAL FIELD

The present disclosure relates to provisioning servers with local storage.

### BACKGROUND

Policy-driven server management involves defining server policies independently of the physical resources being managed. These server policies allow a customer to specify the type and capabilities of the server resources that are required by the customer. When provisioning a server, e.g., from a pool of blade servers, the server needs to be configured with local storage. If the customer requires a level of reliability, the local storage may take the form of a redundant array of independent disks (RAID) device. A management host would first allocate server resources to a customer, and then run a tool on the operating system of the server to configure the RAID volumes, allowing the server resources to access the RAID volume as its local storage.

### BRIEF DESCRIPTION OF THE DRAWINGS

FIG. 1 is a system diagram in which a management controller provisions local storage for servers using a service profile including a local storage profile provided by a management host, according to an example embodiment.

FIG. 2 is a block diagram of a management controller according to an example embodiment.

FIG. 3A is a block diagram of model objects used in defining local storage inventory, according to an example embodiment.

FIG. 3B is a block diagram of model objects used in provisioning a logical unit number (LUN), according to an example embodiment.

FIG. 4A is a Graphical User Interface (GUI) showing the creation of a LUN, according to an example embodiment.

FIG. 4B is a GUI showing the creation of a disk group policy, according to an example embodiment.

FIGS. 5A-5F are system diagrams showing the creation of disk groups and assignment of LUNs to the disk groups, according to an example embodiment.

FIG. 6 is a flow chart illustrating operations to provide local storage to a server using a storage profile in a service profile, according to an example embodiment.

### DESCRIPTION OF EXAMPLE EMBODIMENTS

### Overview

A management controller is provided for provisioning a server with local storage. The management controller receives a service profile that includes a set of local storage criteria. The management controller associates the first service profile with a physical server, and directs a storage controller to create one or more virtual drives that conform to the set of local storage criteria. The management controller provides local storage for the physical server from the virtual drive.

### Example Embodiments

Service profiles are used by customers to request a specific configuration of server resources. Enhancing service profiles with storage profiles for local storage used by the server resources enables the management of the resources to be customized while still being automated. By specifying the desired server resources and automatically configuring the local storage as part of the provisioning the server, the management service can quickly provide customized server resources while maximizing the utility of storage resources. Additionally, the storage profiles may allow the management service to make changes to the logical volumes without requiring rebooting the operating system of the server and without host-based tools to be loaded on the operating system.

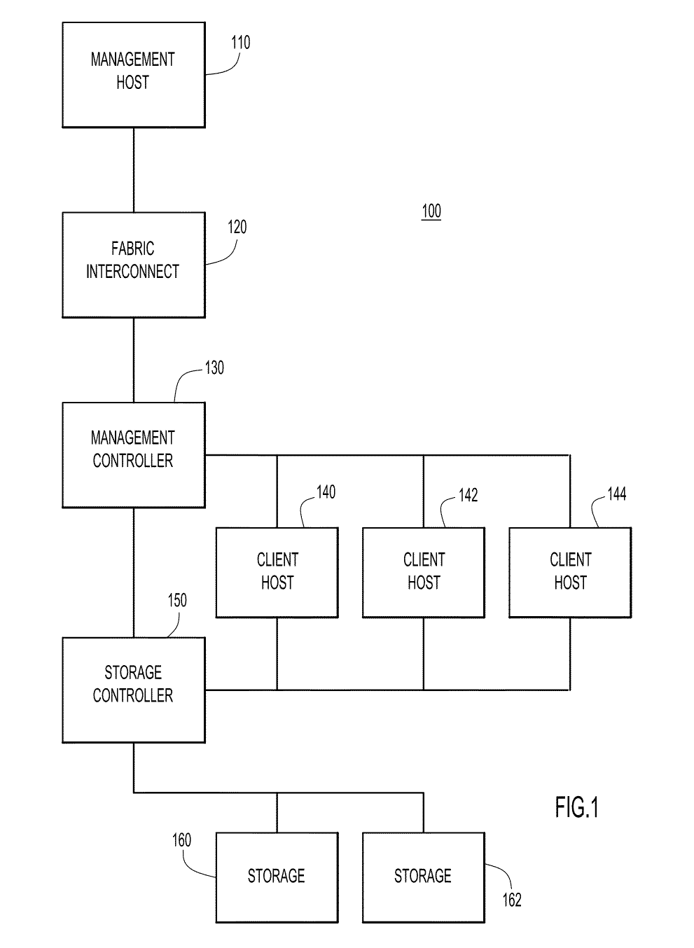

Referring first to FIG. 1, a server management system 100 is shown that enables a client/customer to request server resources with local storage automatically provisioned. The management host 110 provides a service profile including a storage profile over a fabric interconnect 120 to a management controller 130. The management controller 130 controls client hosts 140, 142, and 144 as server resources available for use by customers. Storage controller 150 controls storage devices 160 and 162 that may be used as local storage for the client hosts 140, 142, and/or 144. In one example, more or fewer management controllers, client hosts, storage controllers, and storage devices may be included in system 100.

In one example, a customer acquires the use of server resources by providing a request to the management host 110. The request includes a service profile that describes the server resources (e.g., number of servers, type of servers, performance requirements, etc.) and storage requirements (e.g., number of LUNs, size of LUNs, RAID level, etc.) for the server to use as local storage. The management controller 130 may direct the storage controller 150 to create a virtual drive that meets the criteria in the storage policy if a suitable virtual drive does not exist yet. Once the storage controller 150 has created all of the requested LUNs, the management controller 130 may complete the provisioning of the server resources for the client.

In another example, the storage profile may be created and stored separately from a service profile. In this way, storage profiles may be reused across multiple service profiles. The storage controller 150 may not create the LUNs and virtual drives needed to create the LUNs until the management controller 130 associates specific physical servers with a client request.

In another example, the management controller 130 and the storage controller 150 may communicate through an out-of-band channel, such as an Inter-Integrated Circuit (I²C) bus. The management controller 130 may direct the storage controller 150 to alter one or more aspects of the assigned LUNs without directing the request through the operating system of the client host server to which the LUN is assigned. Since the management controller 130 may not have any access to the operating system of the client server, this out-of-band channel allows the management controller 130 to retain the ability to modify the LUNs without forcing the operating system of the client server to shut down and/or reboot.

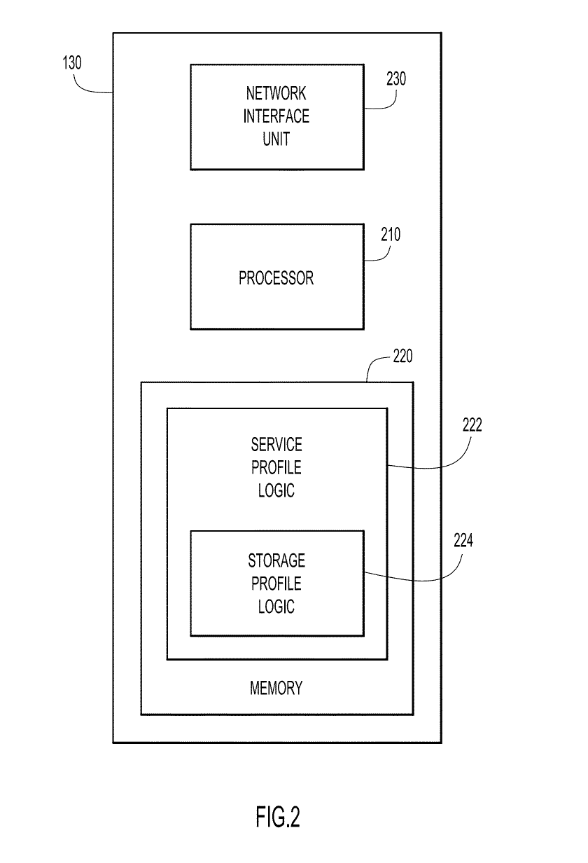

Referring now to FIG. 2, a management controller 130 is shown that includes elements used to process requests for server resources and provisioning local storage for the requested servers. The management controller 130 includes, among other possible components, a processor 210 to process instructions relevant to managing server resources and provisioning local storage, and a memory 220 to store a variety of data and software instructions (e.g., service profile logic 222 and storage profile logic 224). The management controller 130 also includes a network interface unit 230 to communicate with the management host, client hosts, and/or the storage controller, e.g., on a computer network.

Memory 220 may comprise read only memory (ROM), random access memory (RAM), magnetic disk storage media devices, optical storage media devices, flash memory devices, electrical, optical, or other physical/tangible (e.g., non-transitory) memory storage devices. The processor 210 is, for example, a microprocessor or microcontroller that executes instructions for implementing the processes described herein. Thus, in general, the memory 220 may comprise one or more tangible (non-transitory) computer readable storage media (e.g., a memory device) encoded with software comprising computer executable instructions and when the software is executed (by the processor 210) it is operable to perform the operations described herein.

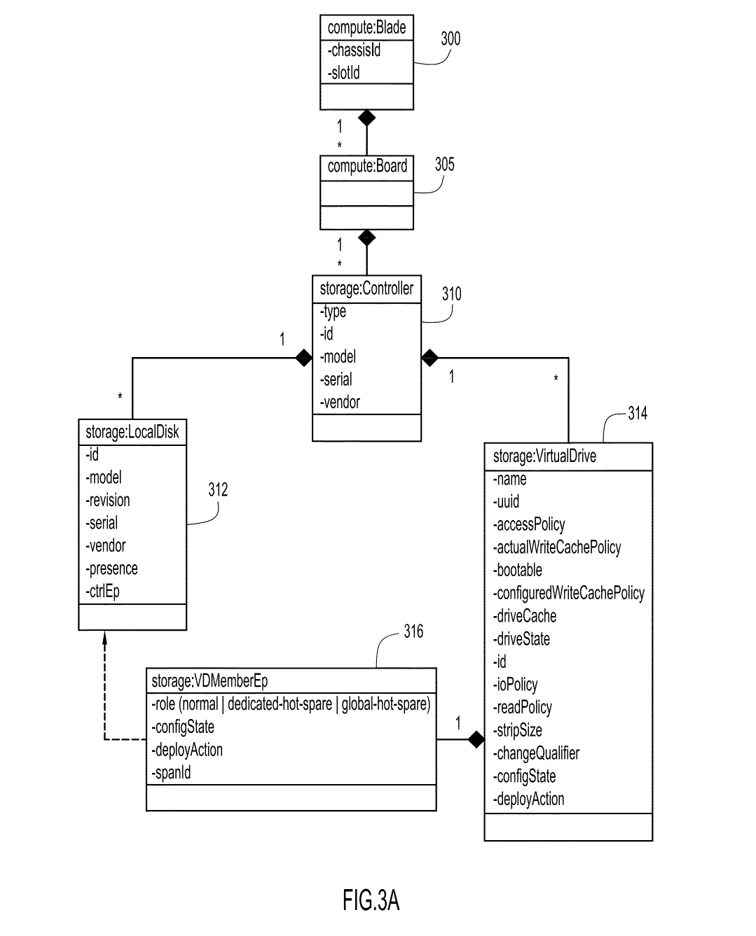

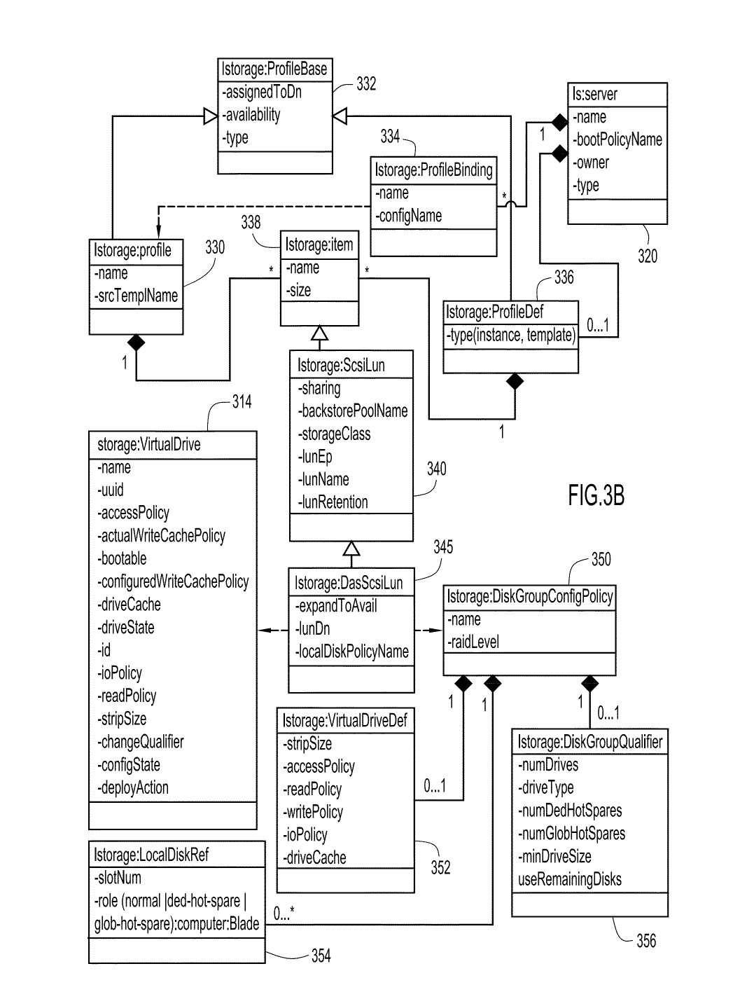

Referring now to FIG. 3A, a block diagram describes the model objects (MOs) for local storage inventory in the system 100. MO 300 describes a physical server, such as a client host 140, with an identifier for the chassis and an identifier for the slot used for local storage. Each server described by an MO 300 is associated with a motherboard described by an MO 305. Each motherboard described by an MO 305 is associated with at least one storage controller 150 described by an MO 310. The MO 310 may include descriptors of the storage controller including the type, the identifier, the model, the serial number, and the vendor of the storage controller.

Each storage controller 150 described by an MO 310 is associated with one or more physical storage disk 160 described by MO 312. The MO 312 may include descriptors of the identifier, model type, revision number, serial number, vendor, presence, and the control endpoint of the storage disk 160. Each storage controller 150 described by an MO 312 may be associated with one or more virtual drives described by an MO 314. The MO 314 may include descriptors of the name, a universally unique identifier (UUID), an access policy, a policy for actually writing to/from the cache, the virtual drive cache, the virtual drive sate, an identifier, an input/output policy, a read policy, a strip size, a change qualifier, and configuration state, and an action to be carried out on deployment of the virtual drive. An MO 316 is used to keep track of the relationship between the virtual drive described by MO 314 and the physical drives described by MO 312. The MO 316 may include descriptors for the role of the physical disk in the virtual drive (e.g., normal, dedicated hot spare, or global hot spare), the configuration state of the local disk in the virtual drive, an action to be carried out on deployment of the virtual drive, an identifier of the span of the virtual drive in the physical drive.

In one example, when the management controller 130 directs the storage controller 150 to create a virtual drive, it assigns a name and ensures that its name is unique within the scope of the server to be deployed. The management controller 130 may identify virtual drives as already present in tis database or as an unknown drive. Virtual drives not present in the database may be known as orphan drives. In another example, clients may use the storage profile to explicitly assign a name for any LUNs created. For orphan drives, the client may rename the orphan drives to reference them in storage profiles and in a boot definition. An orphan drive can only be referenced by the management controller 130 if it has a name and the name is unique.

Referring now to FIG. 3B, a block diagram describes the MOs for LUN provisioning in the system 100. A client host/server 140 is described by MO 320, including descriptors of the server's name, the name of the boot policy for the server, the owner of the server, and the type of the server. The storage profile associated with the MO 320 is described by MOs 330, 332, 334, 336, and 338. MO 330 encapsulates the storage needs of the service profiles, and includes descriptors such as the name of the storage profile and the template name if the storage profile is derived from a template. MO 332 describes the relationship between a general storage profile and a specific instance of a storage profile, and may include descriptors for which disk name the storage profile will be assigned to, the availability of the storage profile, and the type of the storage profile. MO 334 describes a binding from a service profile to a storage profile, and may include descriptors for the name of the profile binding and the configuration name of the binding. There may be multiple bindings between a service profile and multiple storage profiles. This provides flexibility to allow multiple service profiles to re-use the same storage profile, but allows clients to make further customizations for any one service profile. MO 336 defines a single storage profile definition, and includes a descriptor of the type of the storage profile. MO 338 is the basic building block of storage provisioning. This specifies a single LUN, and includes descriptors of the name and size of the LUN.

MO 340 is a refinement of the storage item MO 338, and includes additional properties specific to small computer serial interface (SCSI) LUNs, which may or may not be applicable to local storage. The MO 340 includes descriptors for sharing, a back store pool name, a storage class, a LUN endpoint, a LUN name, and a LUN retention property. MO 345 refines MO 340 further and defines a direct-attached storage (DAS) SCSI LUN. The MO 345 is associated with a virtual drive MO 314, and describes requirements of the virtual drive, such as size and RAID level of the virtual drive. The MO 345 may additionally include descriptors for a local disk policy and whether the virtual drive should expand to fill the available space in disk group.

MO 350 provides a definition of how the storage controller 150 should choose a set of disks on which to create a virtual drive. The MO 350 may include general descriptors for the name of the disk group and the RAID level of the disk group. The disk group is further defined by MOs 352, 354, and 356. MO 352 describes policies to be used by the virtual drive in the disk group, such as the strip size, the access policy, the read policy, the write policy, the input/output policy, and the drive cache. MO 354 is used to specify a physical disk by slot number and the role for the physical disk in the virtual drive. MO 356 provides criteria that may be used to restrict physical disks from being used in a disk group based on properties such as the number of drives available, the type of drives available, the number of dedicated hot spare drives, the number of global hot spares, a minimum drive size, and a indicator to use any remaining disks after all disk groups are allocated.

In one example, a user may specify the creation or use of a local LUN by creating an MO 345 to specify the properties of the LUN. The MO 345 may include an indication of the size required for the LUN, and whether the LUN should expand to fill any additional space in the local storage. The MO 345 may also include a name for a disk group configuration policy. The MO 345 may further include the name inherited from the MO 338 through the MO 340. Alternatively, the MO 345 may include a user-specified name for the LUN. The name of the LUN may be used to specify the LUN in any boot order definitions.

If the name of the LUN is the same as the name of an existing virtual drive, that virtual drive will be used to fulfill the local LUN requirements. In this case, a reference to a disk group policy is not necessary, since the disk group has already been created. However, if a disk group configuration policy is referenced, then the existing virtual drive must meet the requirements of the disk group configuration policy. If there is no existing virtual drive, a disk group configuration policy must be specified, and the virtual drive will be created when the storage policy is associated with specific physical disks.

The disk group configuration policy indicates how a disk group is created for a virtual drive. The policy specifies the name of the policy and the RAID level to be used in the disk group. The disk group configuration policy may further specify manual selection of disks through MO 354 or automatic selection of disks through MO 356.

Automatic selection of the disk group may be restricted by defining and referencing MO 356 to specify one or more of the number of drives, the type of drives (e.g., hard disk drive (HDD), or solid state drive (SSD), etc.), the number of dedicated hot spares, the number of global hot spare drives, the minimum storage size required on each physical drive, and whether the disk group should expand to any additional disks available. In one example, drives of different types will not be selected for the same disk group. In another example, only one disk group will be allowed to expand to include any extra disks available.

Manual selection of the disk group may be specified by creating and referencing MO 354. To manually select a particular disk into a disk group, the MO 354 includes the slot number of the particular disk and the role for the disk, i.e., whether the disk is to be used as a normal disk or a dedicated/global hot spare disk. Since the MO 354 may be defined before a physical server is associated with a storage policy, the slot number defined in the MO 354 may not be valid for a specific server depending on the number of disks in the associated server. In one example, the physical disks are numbered absolutely relative to the platform, and not relative to the controller. In an example with two storage controllers, the disks controlled by the first controller are numbered 1 and 2, and the disks controlled by the second controller are numbered 3 and 4. This maintains consistency with rack servers that have multiple controllers.

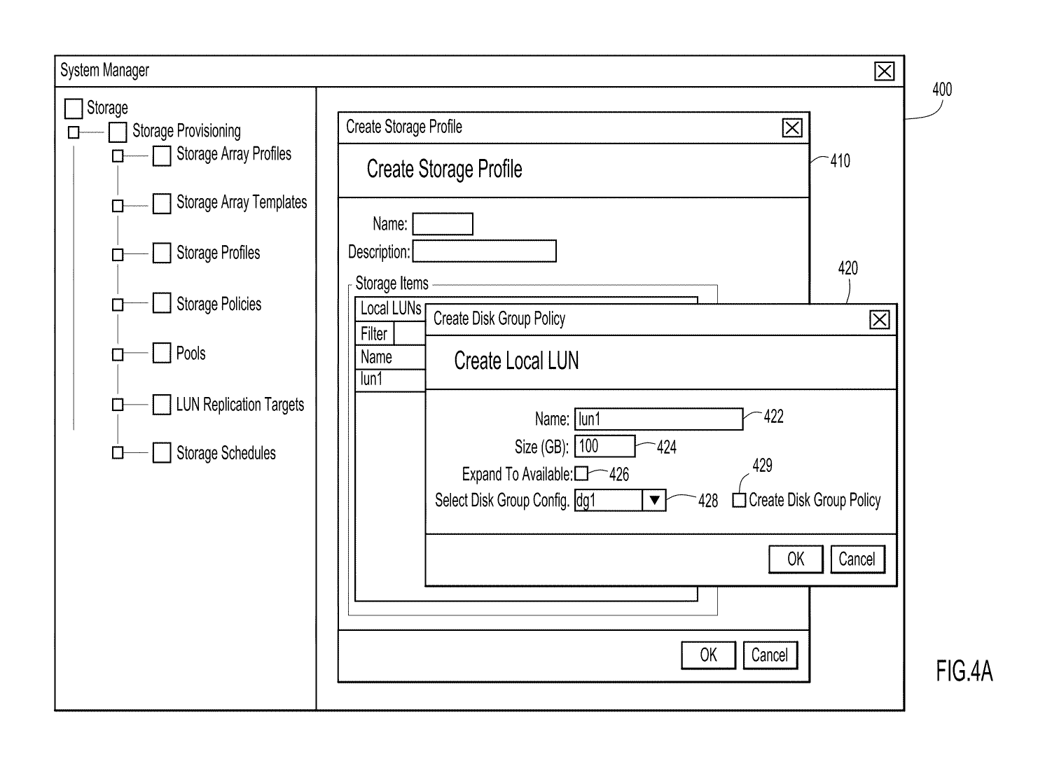

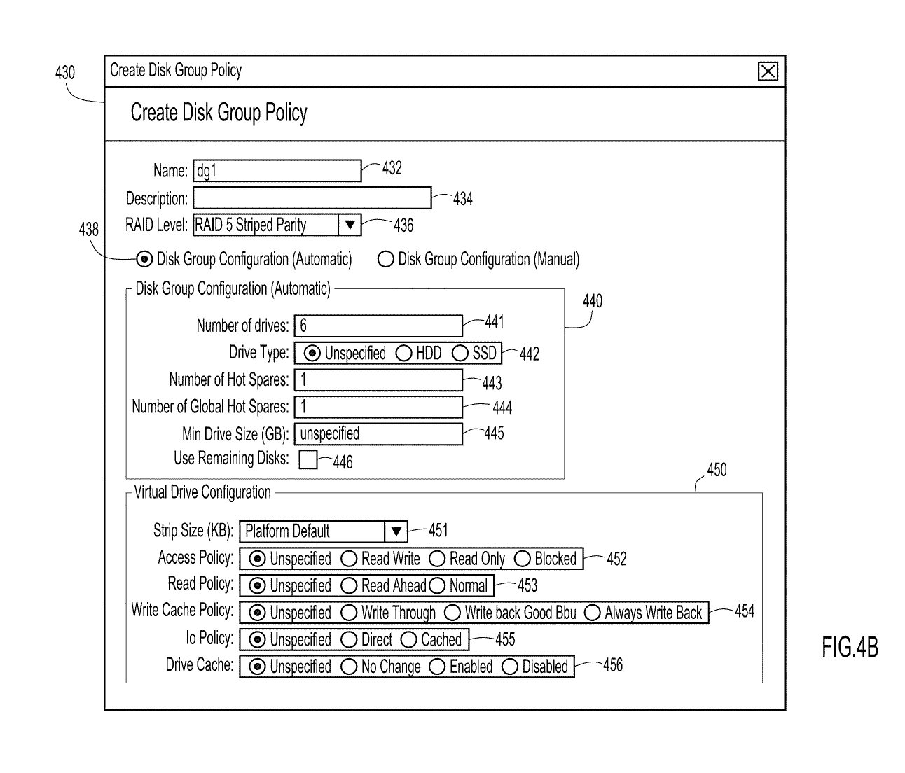

Referring now to FIG. 4A, a GUI displays the creation of a DAS SCSI LUN in the context of a storage profile. The main window 400 displays an inventory of the storage policies defined that can be used in a service profile. Window 410 displays the user interface used in the creation of a new storage profile. Window 420 displays the user interface used in the definition of a LUN to be used in the new storage profile. Window 420 includes an element 422 to enter a name for the LUN, an element 424 to enter the required size of the LUN, and checkbox 426 to allow the LUN to expand to include available disks, as described above. Window 420 also includes drop down element 428 to select an existing disk group configuration policy and a button 429 to create a new disk group configuration policy. In one example, the GUI will create an MO 345 in response to completing window 420.

Referring now to FIG. 4B, the GUI displays window 430 to allow the creation of a new disk group configuration policy. Window 430 includes element 432 to enter the name of the disk group configuration policy and element 434 to enter a brief description of the policy. Drop down element 436 allows the RAID level of the disk group to be selected, and buttons 438 are used to select between automatic selection of disks and manual selection of disks. In one example, the elements 432, 434, 436, and 438 correspond to an MO 350.

In window 430, the button 438 for automatic disk selection is selected, and the automatic selections options are displayed in area 440. The options for automatic disk selection include the number of drives in element 441, the type of drive in element 442, the number of hot spares in element 443, the number of global hot spares in element 444, the minimum drive size in element 445, and checkbox 446 to designate whether the disk group should use the remaining disks. In one example, the elements shown in area 440 correspond to an MO 356

Options for the virtual drive that uses the disk group are selected from area 450. Area 450 includes element 451 to specify the strip size, element 452 to select an access policy, element 453 to select a read policy, element 454 to select a write cache policy, element 455 to select an input/output policy, and element 456 to enable or disable a drive cache. In one example, the elements in area 450 correspond to an MO 352.

In an example in which the disk group is automatically selected according to criteria in an MO 356, there may be more than one way to select disks to satisfy the conditions in the MO 356. The following algorithm describes one possible method for selecting disks in a disk group, but other algorithms are also envisioned.

The management controller 130 iterates over all of the MOs 345 that require the creation of a new virtual drive. The iteration may be based on the following criteria: a) disk type (e.g., SSD or HDD), b) minimum disk size from highest to lowest, c) space required from highest to lowest, d) disk group qualifier name, in alphabetical order, and e) name, in alphabetical order.

In one example, if there are multiple storage controllers 150, the management controller 130 may attempt to fulfill the disk group request in the first storage controller, then move on to the next storage controller if the first storage controller cannot satisfy the request.

In another example, the management controller 130 selects any required global hot spares starting sequentially with the highest numbered disk slot that satisfies the search criteria. Global hot spares may only be selected if there have not already been global hot spares selected for the storage controller of the required disk type. For instance, if one global hot spare has been selected for one virtual drive of type HDD, and another virtual drive requires two global hot spares, then only one additional global hot spare is selected.

In a further example, the management controller 130 selects regular disks depending on the minimum number of disks and minimum disk size. Disks are selected sequentially starting from the lowest numbered disk slot that satisfies the search criteria. If a new virtual drive has the same disk group policy as a deployed virtual drive, then the management controller 130 will attempt to deploy the new virtual drive in the same disk group. Otherwise, the management controller 130 may attempt to find new disks. In one example, a new virtual drive will only be deployed in the disk group of an existing virtual drive with a different disk group policy name if it is not possible to find new disks and the existing disk group satisfies the conditions of the disk group policy (e.g., minimum disk size and RAID level). Dedicated hot spares may be selected in the same manner as regular disks in the disk group.

In yet another example, if the drive type is unspecified in the MO 356, the first available drive type may be chosen. Once chosen, subsequent drives would be of a compatible type. In other words, if the first drive is selected as an SSD, then all other drives would be SSD as well. Similarly, if the first drive is a Serial Attached SCSI (SAS) or Serial Advanced Technology Attachment (SATA) device, then all other drives in the disk group would be the same type.

In still another example, the regular disks, dedicated hot spares, and global hot spares may be allocated atomically within a storage controller 150. If any of the disk conditions cannot be satisfied, then the management controller 130 tries the next storage controller 150. Additionally, disks may be chosen for a new disk group only if they were previously in an unconfigured good state.

After all of the virtual drives have been allocated, any unallocated disks may be added to the virtual drive that is configured through the MO 356 to use the remaining disks. In one example, only a single MO 356 may be set to have this property. Additionally, a virtual drive defined by an MO 345 that includes a property to expand to any available space may be allocated any remaining space in the disk group for that virtual drive. In one example, only a single MO 345 with a given RAID level can include this property.

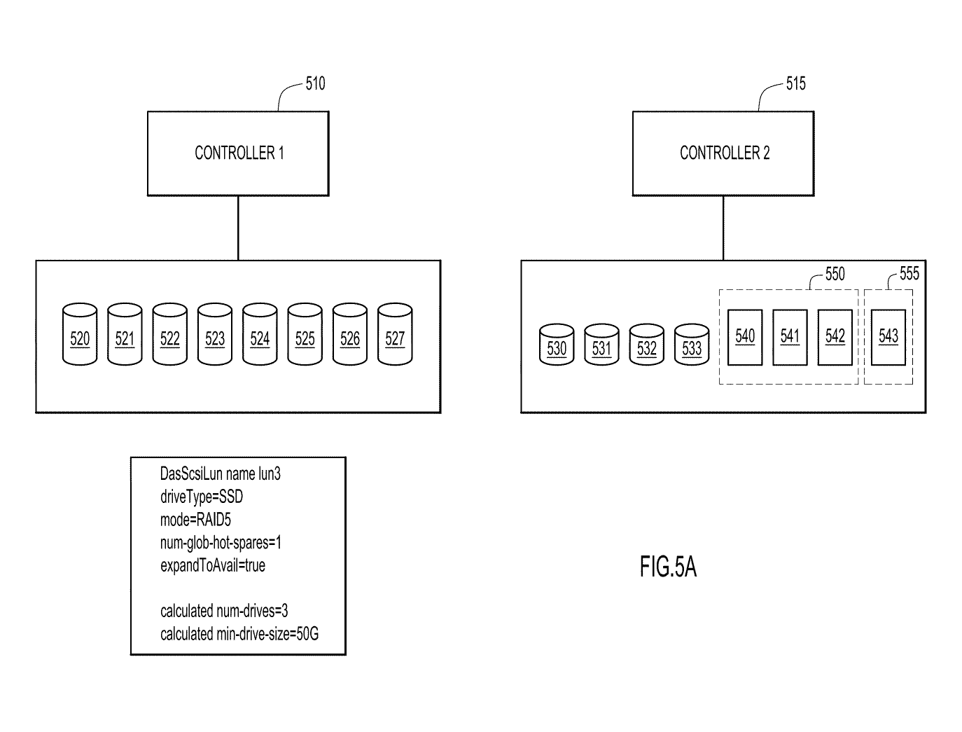

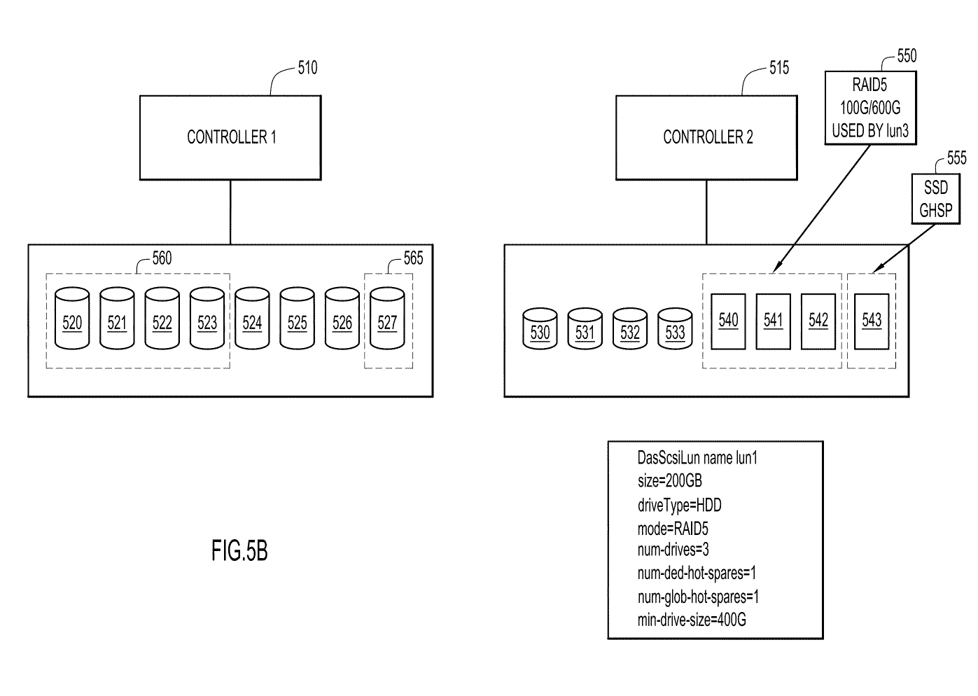

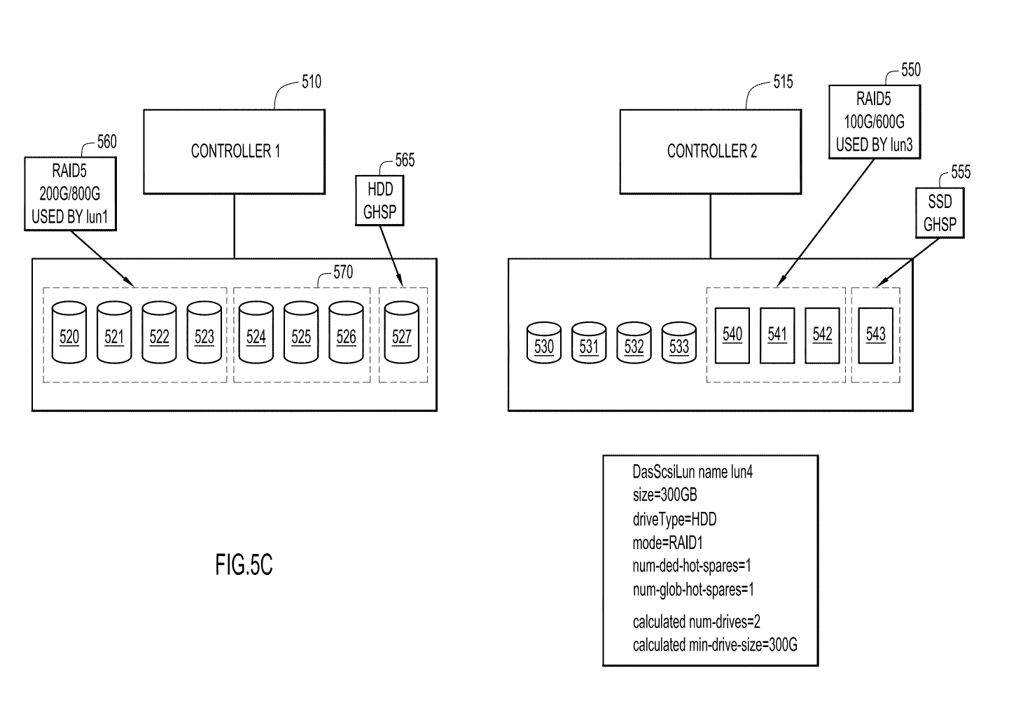

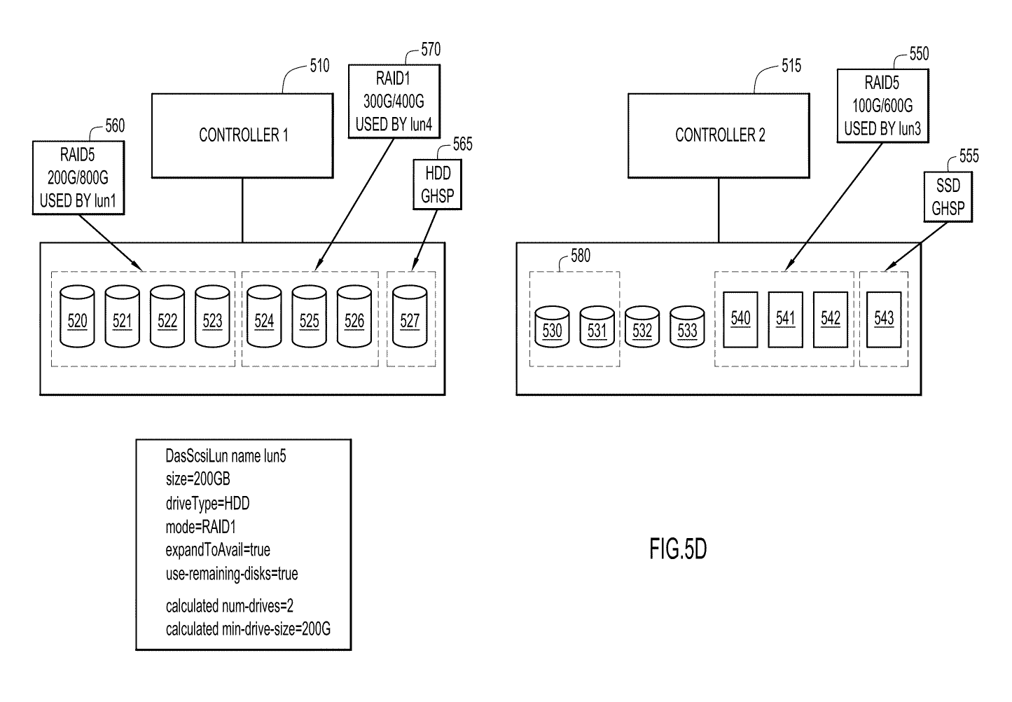

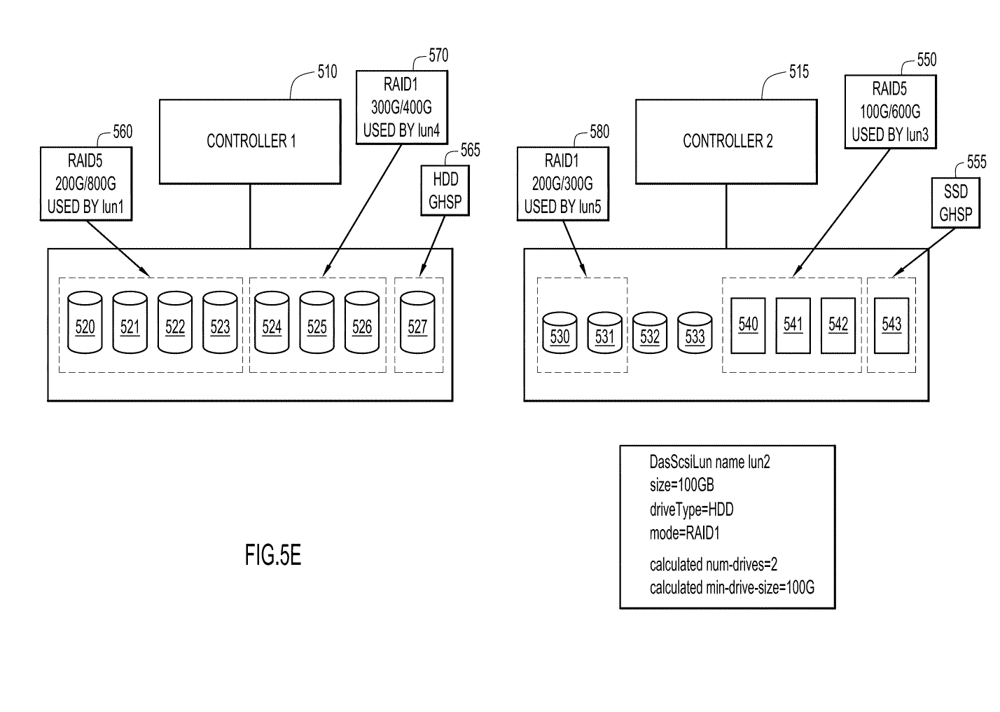

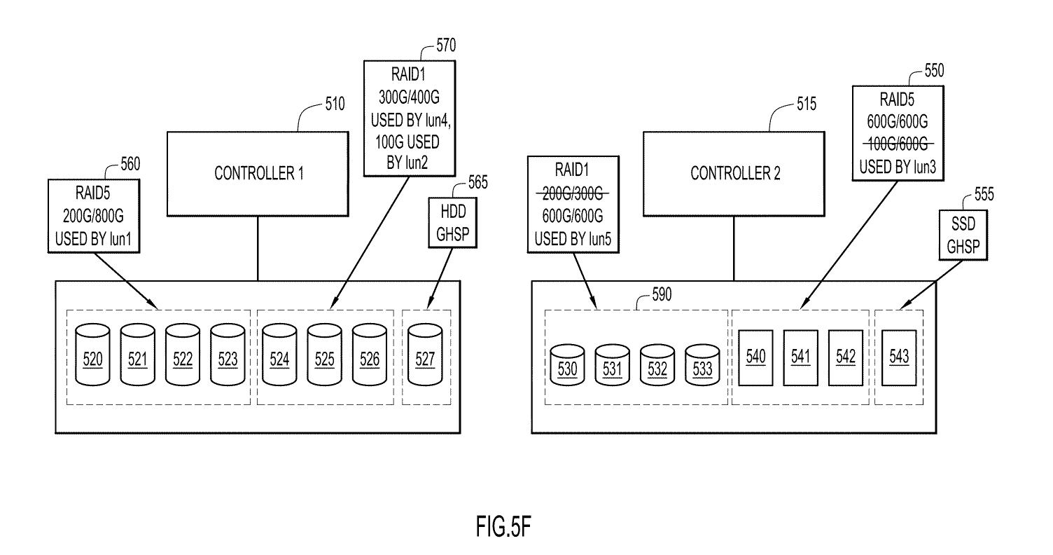

A detailed example of disk selection and allocation into disk groups is described below with reference to FIGS. 5A-5F. In this example, a service profile is being provisioned with five LUNs, each having the characteristics listed in Table I. The search order is calculated from the criteria as described above, i.e., taken in order of drive type, minimum drive size, LUN size, and name.

TABLE I
Criteria for Provisioning LUNs in an example storage profile

| LUN | | Drive | | | search |
|---|---|---|---|---|---|
| Name | Size | Type | mode | other properties | order |
| lun1 | 200 GB | HDD | RAID5 | num-drives = 3, num-ded-hot-spares = 1, | 2 |
| | | | | num-glob-hot-spares = 1, min-drive-size = 400 GB | |
| lun2 | 100 GB | HDD | RAID1 | (calculated min-drive-size = 100 GB) | 5 |
| lun3 | 100 GB | SSD | RAID5 | num-glob-hot-spares = 1, expandToAvail = true | 1 |
| | | | | (calculated min-drive-size = 50 GB) | |
| lun4 | 300 GB | HDD | RAID1 | num-ded-hot-spares = 1, num-glob-hot-spares = 1 | 3 |
| | | | | (calculated min-drive-size = 300 GB) | |
| lun5 | 200 GB | HDD | RAID1 | expandToAvail = true, use-remaining-disks = true | 4 |
| | | | | (calculated min-drive-size = 200 GB) | |

Referring now to FIG. 5A, a block diagram shows the allocation of a disk group to lun3, the first LUN to be provisioned in the search order of Table I. In this example, a management controller has access to storage controllers 510 and 515. Storage controller 510 controls eight HDDs 520-527, with each HDD 520-527 having a capacity of 400 GB. Storage controller 515 controls four HDDs 530-533, with each HDD 530-533 having a capacity of 300 GB. Storage controller 515 also controls four SSDs 540-543, with each SSD having a capacity of 300 GB.

In allocating a disk group for lun3, SSDs 540, 541, and 542 are selected as regular disks in group 550, and SSD 543 is selected as the global hot spare in group 555. This disk group 550 configured in RAIDS mode will have a capacity of 600 GB, though only 100 GB is allocated for lun3 initially. Since the expandToAvail property is set to true, the storage controller 515 will allocate up to the remaining 500 GB to lun3 at the end of the disk group allocation process, after any other virtual drives have been allocated to disk groups.

Referring now to FIG. 5B, a block diagram shows the allocation of a disk group to lun1, the second LUN to be provisioned in the search order of Table I. In selecting resources for lun1, storage controller 510 selects HDDs 520, 521, and 522 as regular disks, and HDD 523 as the dedicated hot spare, collectively designated as group 560. HDD 527 is selected as the HDD global hot spare for controller 510 as designated by group 565. This disk group 560 configured in RAIDS mode has a capacity of 800 GB, of which 200 GB is used for lun1.

Referring now to FIG. 5C, a block diagram shows the allocation of a disk group to lun4, the third LUN to be provisioned in the search order of Table I. In selecting resources for lun4, storage controller 510 selects HDD 524 and 525 as regular disks, and HDD 526 as the dedicated hot spare, collectively designated as group 570. HDD 527 is already designated as the global hot spare for storage controller 510, and is now being used as the global hot spare for both lun1 and lun4. The disk group 570 configured in RAID1 mode has a capacity of 400 GB, of which 300 GB is used for lun4.

Referring now to FIG. 5D, a block diagram shows the allocation of a disk group to lun5, the fourth LUN to be provisioned in the search order of Table I. In selecting resources for lun5, storage controller 510 does not have any available disk groups, since group 560 is configured in the wrong RAID mode, and group 570 does not have enough free capacity to hold the 200 GB that lun5 requires. Storage controller 515 selects HDD 530 and 531 as regular disks, designated as disk group 580. The disk group 580 configured in RAID 1 mode has a capacity of 300 GB using two HDDs, of which 200 GB is used for lun5. Since the property of use-remaining-disks is set to true, additional disks may be added after the other LUNs have been allocated to disk groups. Additionally, since the property of expandToAvail is set to true, any remaining space in disk group 580 may be allocated to lun5 after the other LUNs have been allocated to disk groups.

Referring now to FIG. 5E, a block diagram shows the allocation of a disk group to lun2, the fifth LUN to be provisioned in the search order of Table I. Since the already formed disk group 570 is configured with the same RAID mode and has sufficient capacity, storage controller 510 selects HDDs 524 and 525 as regular disks for lun2. The dedicated hot spare of lun4, i.e., HDD 526, was not requested for lun2, but its presence does not prevent the selection of the remaining space in disk group 570 for lun2. After allocating space for lun2, disk group 570 has a total capacity of 400 GB, with 300 GB used for lun4 and 100 GB used for lun2.

Referring now to FIG. 5F, a block diagram shows how disks and space within disk groups are adjusted to satisfy the requests by lun3 and lun5. Since lun3 has the property expandToAvail set to true, the size of lun3 is increased to the full 600 GB available in disk group 550. Additionally, since lun5 has the property use-remaining-disks set to true, HDDs 532 and 533 are added to disk group 580 to create a new disk group 590 with a total capacity of 600 GB. Further, since lun5 has the property expandToAvail set to true, the size of lun5 is increased to the full 600 GB of disk group 590. Disk group 560 remains unchanged with 200 GB of its total 800 GB allocated to lun1. Disk group 570 also remains unchanged with 300 GB of its total 400 GB allocated to lun4, and the remaining 100 GB allocated to lun2.

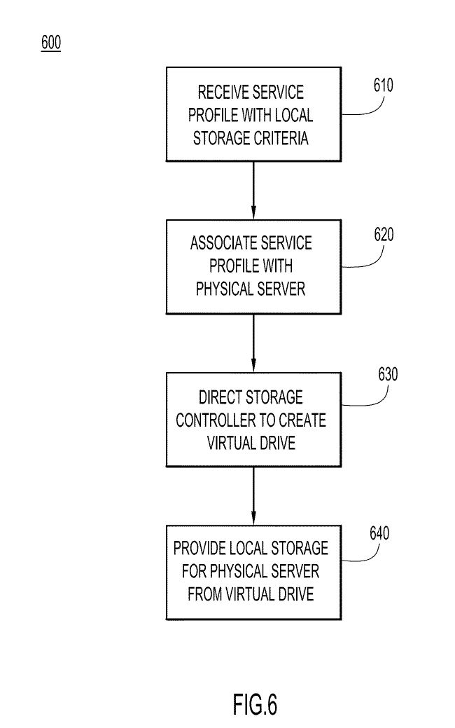

Referring now to FIG. 6, a process 600 is described for operations performed by the management controller in using a storage profile to provision local storage for a server. In step 610, the management controller receives a service profile with requirements for server resources, including a storage profile. The management controller associates the service profile with a physical server in step 620. In step 630, the management controller directs a storage controller to create one or more virtual drives that conform to the LUNs specified in the storage profile. In step 640, the management controller provides local storage for the physical servers as LUNs from the virtual drives.

In summary, the storage profile described herein allows a user to automatically provision local storage resources on a server. The user can define the configuration of the local storage ahead of time along with any other server configuration information. The type of storage configuration is flexible and allows for multiple virtual drives. The configuration of the storage resources is done automatically without any need for additional tools running on the server's operating system.

In one form, a method is provided for provisioning a server with local storage. A management controller receives a first service profile comprising a first set of local storage criteria. The management controller associates the first service profile with a first physical server, and directs a first storage controller to create a first virtual drive. The first virtual drive conforms to the first set of local storage criteria. The management controller provides local storage for the first physical server from the first virtual drive.

In another form, an apparatus is provided comprising a network interface, a memory, and a processor coupled to the memory and the network interface unit. The network interface communicates with one or more computing devices. The processor receives a first service profile via the network interface. The first service profile comprises a first set of local storage criteria. The processor associates the first service profile with a first physical server, and directs a first storage controller to create a first virtual drive. The first virtual drive conforms to the first set of local storage criteria. The processor provides local storage for the first physical server from the first virtual drive.

In yet another form, a system is provided comprising a management host, one or more storage controllers, a server pool, and a management controller. The management host provides a first service profile. The storage controllers provide access to one or more physical storage drives. The server pool comprises one or more physical servers. The management controller receives the first service profile comprising a first set of local storage criteria. The management controller further associates the first service profile with a first physical server from the server pool. The management controller directs a first storage controller form the one or more storage controllers to create a first virtual drive from the one or more physical storage drives. The first virtual drive satisfies the first set of local storage criteria from the first storage profile. The management controller provides local storage for the first physical server from the first virtual drive.

The above description is intended by way of example only. Various modifications and structural changes may be made therein without departing from the scope of the concepts described herein and within the scope and range of equivalents of the claims.

What is claimed is:

1. A method comprising:
receiving a first service profile comprising a first set of local storage criteria;
associating the first service profile with a first physical server;
directing a first storage controller to create a first virtual drive that conforms to the first set of local storage criteria; and
providing local storage for the first physical server from the first virtual drive.

2. The method of claim 1, wherein the first physical server is selected from a server pool based on the first service profile.

3. The method of claim 1, wherein the first set of local storage criteria includes criteria related to at least one of Redundant Array of Independent Devices (RAID) level, size of drive, number of physical drives, type of physical drive, or slot number of physical drives.

4. The method of claim 1, further comprising:
receiving a second service profile comprising a second set of local storage criteria;
associating the second service profile with a second physical server;
directing a second storage controller to create a second virtual drive that conforms to the second set of local storage criteria; and
providing local storage for the second physical server from the second virtual drive.

5. The method of claim 1, wherein the first set of local storage criteria includes criteria for at least one additional virtual drive, the method further comprising:
directing the first storage controller to create at least one additional virtual drive; and
providing local storage for the first physical server from the first virtual drive and the at least one additional virtual drive.

6. The method of claim 1, further comprising:
receiving a modified service profile comprising a modified set of local storage criteria;
directing the first storage controller to modify the first virtual drive to conform to the modified set of local storage criteria; and
updating the local storage of the first physical server.

7. The method of claim 6, wherein the first storage controller is directed to modify the first virtual drive by an out-of-band interface, such that the local storage of the local storage of the first physical server is updated without rebooting an operating system of the first physical server.

8. An apparatus comprising:
a network interface to communicate with one or more computing devices;
a memory; and
a processor coupled to the memory and the network interface, wherein the processor:
receives a first service profile via the network interface, the first service profile comprising a first set of local storage criteria;
associates the first service profile with a first physical server;
directs a first storage controller to create a first virtual drive that conforms to the first set of local storage criteria; and
provides local storage for the first physical server from the first virtual drive.

9. The apparatus of claim 8, wherein the processor selects the first physical server from a server pool based on the first service profile.

10. The apparatus of claim 8, wherein the first set of local storage criteria includes criteria related to at least one of Redundant Array of Independent Devices (RAID) level, size of drive, number of physical drives, type of physical drive, or slot number of physical drives.

11. The apparatus of claim 8, wherein the processor further:
receives a second service profile via the network interface, the second service profile comprising a second set of local storage criteria;
associates the second service profile with a second physical server;
directs a second storage controller to create a second virtual drive that conforms to the second set of local storage criteria; and
provides local storage for the second physical server from the second virtual drive.

12. The apparatus of claim 8, wherein the first set of local storage criteria includes criteria for at least one additional virtual drive, and the processor further:
directs the first storage controller to create at least one additional virtual drive; and
provides local storage for the first physical server from the first virtual drive and the at least one additional virtual drive.

13. The apparatus of claim 8, wherein the processor further:
receives a modified service profile via the network interface, the modified service profile comprising a modified set of local storage criteria;
directs the first storage controller to modify the first virtual drive to conform to the modified set of local storage criteria; and
updates the local storage of the first physical server.

14. The apparatus of claim 13, wherein the processor directs the first storage controller to modify the first virtual drive by an out-of-band interface, such that the local storage of the local storage of the first physical server is updated without rebooting an operating system of the first physical server.

15. A system comprising:
a management host to provide a first service profile;
one or more storage controllers to provide access to one or more physical storage drives;
a server pool comprising one or more physical servers;
a management controller to:
receive the first service profile comprising a first set of local storage criteria;
associate the first service profile with a first physical server from the server pool;
direct a first storage controller from the one or more storage controllers to create a first virtual drive from the one or more physical storage drives, the first virtual drive conforming to the first set of local storage criteria; and
provide local storage for the first physical server from the first virtual drive.

16. The system of claim 15, wherein the first set of local storage criteria includes criteria related to at least one of Redundant Array of Independent Devices (RAID) level, size of drive, number of physical drives, type of physical drive, or slot number of physical drives.

17. The system of claim 15, wherein the management controller further:
receives a second service profile comprising a second set of local storage criteria;
associates the second service profile with a second physical server from the server pool;
directs a second storage controller selected from the one or more storage controllers to create a second virtual drive from the one or more physical storage drives, the second virtual drive conforming to the second set of local storage criteria; and
provides local storage for the second physical server from the second virtual drive.

18. The system of claim 15, wherein the first set of local storage criteria includes criteria for at least one additional virtual drive, the management controller further:
directing the first storage controller to create at least one additional virtual drive; and
providing local storage for the first physical server from the first virtual drive and the at least one additional virtual drive.

19. The system of claim 15, wherein the management controller further:
receives a modified service profile from the management host, the modified service profile comprising a modified set of local storage criteria;
directs the first storage controller to modify the first virtual drive to conform to the modified set of local storage criteria; and
updates the local storage of the first physical server.

20. The system of claim 19, wherein the management controller directs the first storage controller to modify the first virtual drive by an out-of-band interface, such that the local storage of the local storage of the first physical server is updated without rebooting an operating system of the first physical server.
